(19) United States
(12) Patent Application Publication
(10) Pub. No.: US 2025/0231799 A1
(43) Pub. Date: Jul. 17, 2025

(54) INFORMATION PROCESSING METHOD, INFORMATION PROCESSING APPARATUS, AND PROGRAM FOR MODIFYING CONTROL CONTENT OF APPLIANCE

(71) Applicant: Panasonic Intellectual Property Corporation of America, Torrance, CA (US)

(72) Inventors: Ryoji MORI, Saitama (JP); Takuya YAMAGUCHI, Osaka (JP); Kenta MURAKAMI, Osaka (JP); Masashi OTANI, Osaka (JP)

(73) Assignee: Panasonic Intellectual Property Corporation of America, Torrance, CA (US)

(21) Appl. No.: 19/098,859

(22) Filed: Apr. 2, 2025

Related U.S. Application Data
(63) Continuation of application No. PCT/JP2023/030482, filed on Aug. 24, 2023.

(30) Foreign Application Priority Data
Oct. 5, 2022 (JP) 2022-160943

(51) Int. Cl. G06F 9/48

(52) U.S. Cl. CPC G06F 9/4881

(57) ABSTRACT

A receiver receives information on a first block sequence that is a block sequence scheduled to be executed by an appliance, and the specifier specifies a second block similar to a first block included in the first block sequence from a second block sequence that is a block sequence having already been executed. A processor modifies the first block based on a determination flag indicating a preference of a user for the second block and a modification value for a parameter of the second block. An outputter outputs the first block sequence including the modified first block.

This application is based upon and claims the benefit of priority from the prior Japanese Patent Application No. 2022-160943, filed on Oct. 5, 2022, the entire contents of which are incorporated herein by reference.

### BACKGROUND

### 1. Technical Field

The present disclosure relates to information processing technology, and particularly, to an information processing method, an information processing apparatus, and a program for modifying control content of an appliance.

### 2. Description of the Related Art

In the conventional practice, it is required for a cooker to achieve a degree of doneness that is preferred by a user. The user visually confirms the doneness of a dish in the cooker, and inputs an additional heating instruction in a case of determining that the heating is insufficient.

The cooker starts additional heating in response to the input of the instruction, and changes cooking parameters in a recipe information in response to input information on the additional heating (see, for example, JP 2019-219105 A).

In JP 2019-219105 A, if a parameter is changed for one appliance, the changed parameter is also reflected in the next use of the appliance. On the other hand, it is also desirable to reflect the change in the parameter between different appliances.

### SUMMARY

The present disclosure has been made in view of such a situation, and an object of the present disclosure is to provide a technique for reflecting change in a parameter between different appliances.

In order to solve the above problem, an information processing method according to one aspect of the present disclosure includes: a step of receiving information on a first block sequence that is a block sequence in which blocks defined in a functional unit executable by an appliance are arranged in an order of operation and that is a block sequence scheduled to be executed by the appliance; a step of specifying a second block similar to a first block included in the first block sequence from a second block sequence that is the block sequence having already been executed by an appliance of a type different from a type of the appliance scheduled to execute; a step of modifying the first block based on a determination flag indicating a preference of a user for the second block and a modification value for a parameter of the second block; and a step of outputting the first block sequence including the modified first block.

Another aspect of the present disclosure is also an information processing method. The method includes: a step of receiving information on a block sequence that is a block sequence in which blocks defined in a functional unit executable by an appliance are arranged in an order of operation and that is scheduled to be executed by the appliance; a step of receiving a first determination flag indicating a preference of a user scheduled to cause the appliance to execute the block sequence; a step of modifying the first block using a database storing information on a plurality of second blocks that are similar to the first block included in the block sequence and that have already been executed by another user; and a step of outputting the block sequence including the modified first block. The database stores, for each of the plurality of second blocks, a second determination flag indicating a preference of the other user, a subjective evaluation of the other user, and a modification value for a parameter of each of the second blocks. In the step of modification, (1) the second blocks having the second determination flag with the same content as the first determination flag are selected from the database, (2) the second blocks having a relatively high subjective evaluation are further selected from the selected second blocks, and (3) the first block is modified based on the modification value for the further selected second blocks and the first determination flag.

Still another aspect of the present disclosure is an information processing apparatus. The apparatus includes: a receiver structured to receive information on a first block sequence that is a block sequence in which blocks defined in a functional unit executable by an appliance are arranged in an order of operation and that is a block sequence scheduled to be executed by the appliance; a specifier structured to specify a second block similar to a first block included in the first block sequence from a second block sequence that is the block sequence having already been executed by an appliance of a type different from a type of the appliance scheduled to execute; a processor structured to modify the first block based on a determination flag indicating a preference of a user for the second block and a modification value for a parameter of the second block; and an outputter structured to output the first block sequence including the modified first block.

Still another aspect of the present disclosure is also an information processing apparatus. The apparatus includes: a first receiver structured to receive information on a block sequence that is a block sequence in which blocks defined in a functional unit executable by an appliance are arranged in an order of operation and that is scheduled to be executed by the appliance; a second receiver structured to receive a first determination flag indicating a preference of a user scheduled to cause the appliance to execute the block sequence; a processor structured to modify the first block using a database storing information on a plurality of second blocks that are similar to the first block included in the block sequence and that have already been executed by another user; and an outputter structured to output the block sequence including the modified first block. The database stores, for each of the plurality of second blocks, a second determination flag indicating a preference of the other user, a subjective evaluation of the other user, and a modification value for a parameter of each of the second blocks. The processor (1) selects the second blocks having the second determination flag with the same content as the first determination flag from the database, (2) further selects the second blocks having a relatively high subjective evaluation from the selected second blocks, and (3) modifies the first block based on the modification value for the further selected second blocks and the first determination flag.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

FIGS. 1A to 1G show configurations of an appliance control system according to a first embodiment;

FIGS. 2A to 2E show configurations of the functional blocks used in the appliance control system of FIGS. 1A to 1G;

FIGS. 3A to 3H show configurations of the functional block sequences used in the appliance control system of FIGS. 1A to 1G;

FIG. 4 shows an overview of the operation of the appliance of FIGS. 1A to 1G;

FIG. 5 shows another configuration of the appliance control system of FIGS. 1A to 1G;

FIG. 6 shows a configuration of the appliance of FIG. 5;

FIG. 7 shows a configuration of an information processing apparatus of FIG. 5;

FIGS. 8A to 8C show functional block sequences executed by the appliance in FIG. 5;

FIGS. 9A and 9B show a subjective evaluation input by an operator of FIG. 6;

FIG. 10 shows data generated in a processor of FIG. 6;

FIG. 11 shows a data structure of a table stored in a storage of FIG. 7;

FIG. 12 shows a functional block sequence scheduled to be executed in the appliance of FIGS. 1A to 1G;

FIG. 13 shows a data structure of the table stored in the storage of FIG. 7;

FIG. 14 shows a data structure of another table stored in the storage of FIG. 7;

FIG. 15 shows a data structure of still another table stored in the storage of FIG. 7;

FIG. 16 shows a functional block sequence including functional blocks modified in a processor of FIG. 7;

FIG. 17 is a flowchart showing a storage procedure by the information processing apparatus of FIG. 5;

FIG. 18 is a flowchart showing a modification procedure by the information processing apparatus of FIG. 5;

FIG. 19 shows a data structure of a history DB according to a second embodiment; and

FIG. 20 is a flowchart showing a modification procedure by an information processing apparatus according to the second embodiment.

### DETAILED DESCRIPTION

The invention will now be described by reference to the preferred embodiments. This does not intend to limit the scope of the present invention, but to exemplify the invention.

### First Embodiment

All of the embodiments described below show preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features shown in the figures are denoted by identical symbols, and a duplicate description is omitted or simplified. Hereinafter, the embodiments will be described in the order of (1) overviews of functional blocks and functional block sequences, (2) configurations of appliance control system, and (3) reflection of changes in functional blocks.

### (1) Overviews of Functional Blocks and Functional Block Sequences

In household electrical/mechanical appliances such as a rice cooker, washing machine, and microwave oven (hereinafter referred to as “appliances”), the function/operation of hardware is controlled by software for realizing a specific function. In this embodiment, an appliance control system is introduced as a mechanism to enable creation or updating of software for controlling the appliance.

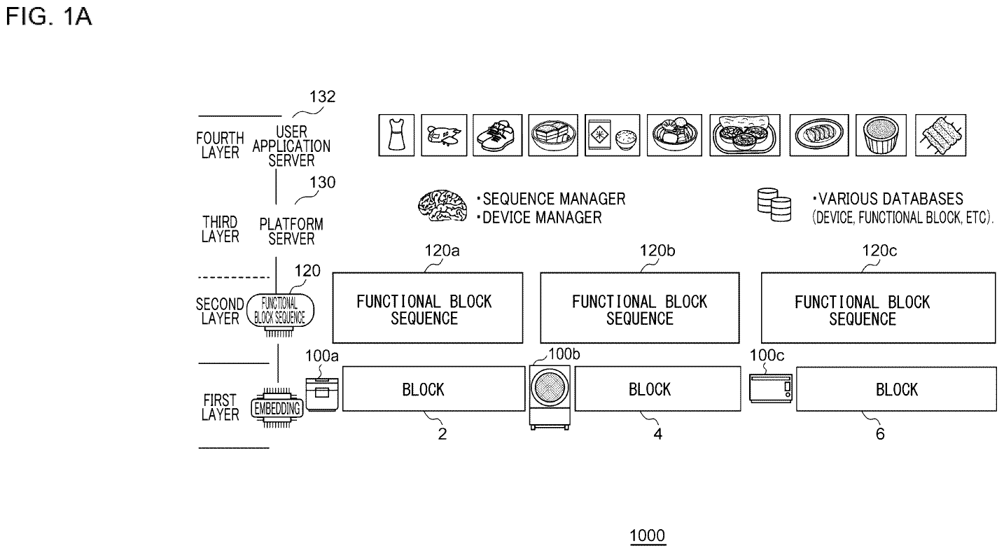

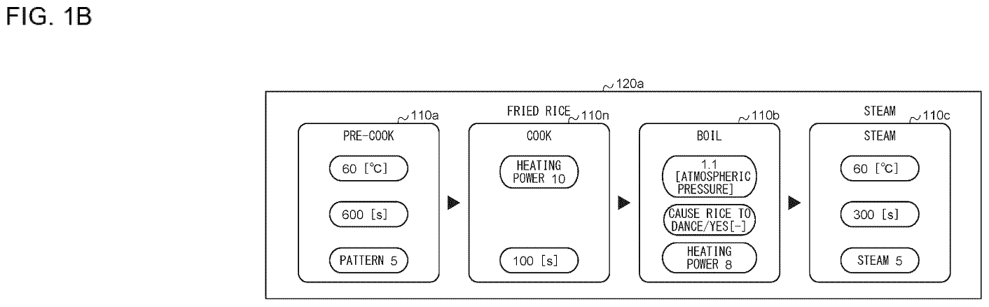

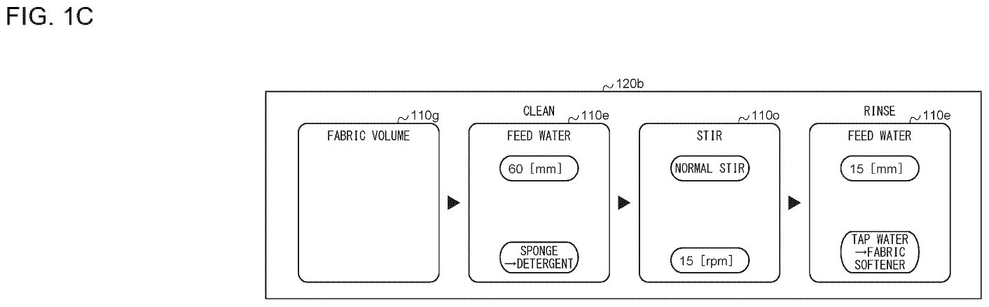

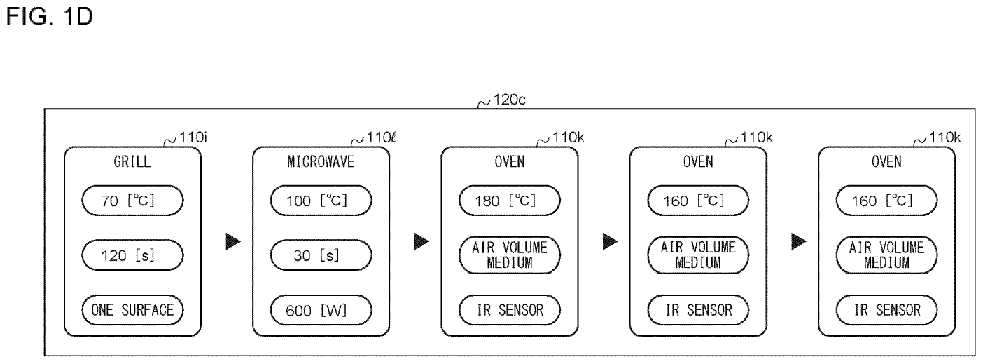

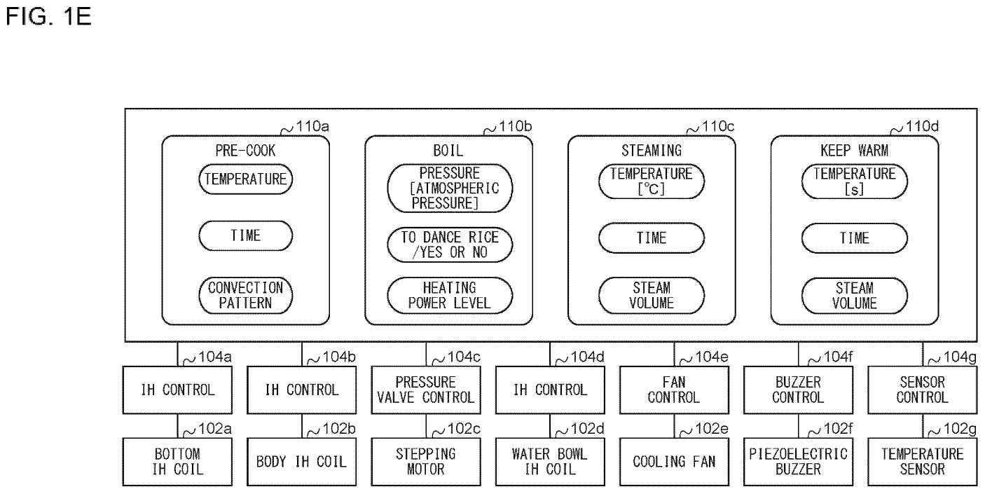

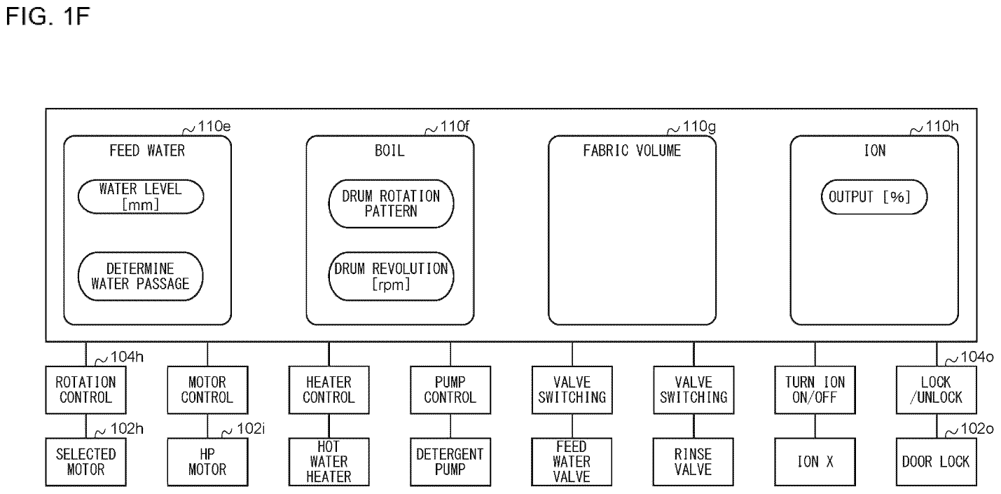

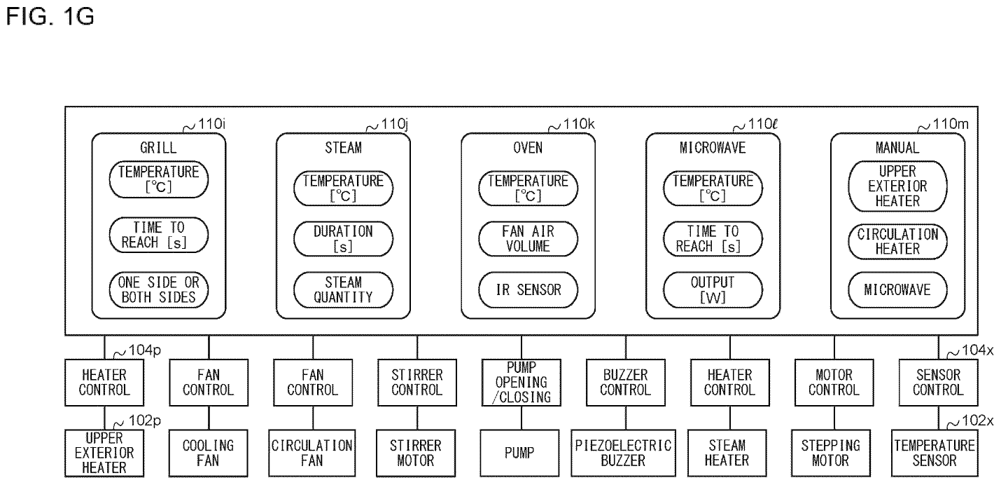

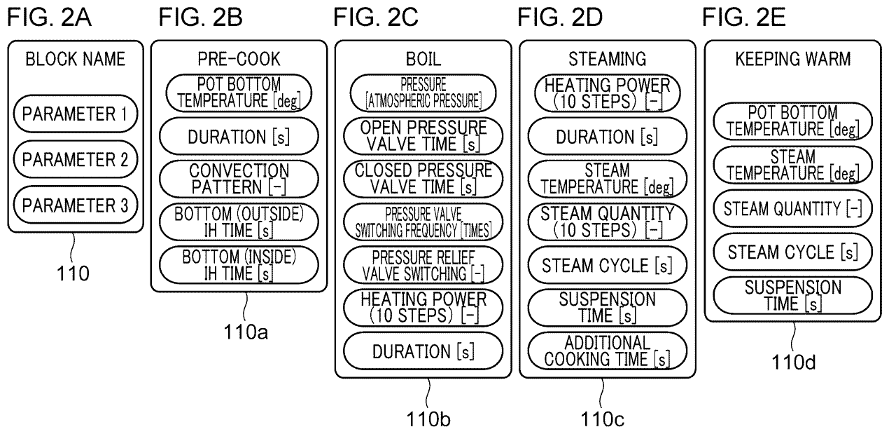

FIGS. 1A to 1G show configurations of an appliance control system 1000. In the appliance control system 1000, a four-layer model composed of the first to fourth layers is defined. In the first layer, the configuration of an appliance 100 is defined. The appliance 100 is, for example, a rice cooker (appliance 100a), a washing machine (appliance 100b), and a microwave oven (appliance 100c). The appliance 100 is not limited thereto. Each appliance 100 includes a block 2 (FIG. 2E), a block 4 (FIG. 2F), a block 6 (FIG. 2G), a plurality of components 102, a plurality of drivers 104, and a plurality of functional blocks 110.

The component 102 is a hardware element constituting a unit derived from dividing the operation (actuation/sensing) of the appliance 100 and includes an actuator and a sensor that execute the function of the appliance 100. The actuator is an output device and the sensor is an input device. The actuator includes, for example, a bottom IH (Induction Heating) coil (component 102a), a body IH coil (component 102b), a stepping motor (component 102c), a water bowl IH coil (component 102d), a cooling fan (component 102e), and a piezoelectric buzzer (component 102f) in the rice cooker (appliance 100a). The sensor is, for example, a temperature sensor (component 102g) in the rice cooker (appliance 100a). The component 102 included in the rice cooker (appliance 100a) is not limited to these, and the washing machine (appliance 100b) and the microwave oven (appliance 100c) are similarly configured.

The driver 104 is software for directly controlling the component 102. IH control (driver 104) in the rice cooker (appliance 100a) controls the bottom IH coil (component 102a). Further, IH control (driver 104b) controls the body IH coil (component 102b), pressure valve control (driver 104c) controls the stepping motor (component 102c), and IH control (driver 104d) controls the water bowl IH coil (component 102d). Further, fan control (driver 104e) controls the cooling fan (component 102e), buzzer control (driver 104f) controls the piezoelectric buzzer (component 102f), and sensor control (driver 104g) controls the temperature sensor (component 102g). The driver 104 included in the rice cooker (appliance 100a) is not limited to these, and the washing machine (appliance 100b) and the microwave oven (appliance 100c) are similarly configured.

The functional block 110 is a software interface (API: Application Programming Interface) associated with one or more drivers 104 to cause one or more components 102 to operate. The functional block 110 can receive one or more parameters for controlling the operation of the (each) component 102. Details of the functional block 110 will be described later.

In the second layer, a functional block sequence 120 in which one or more functional blocks 110 are arranged in the order of operation is defined to cause the appliance 100 to execute an intended process. That is, the functional block sequence 120 defines the order of execution of one or more functional blocks 110. The intended process is defined according to the appliance 100, and is, for example, cooking in the case of the rice cooker (appliance 100a) and the microwave oven (appliance 100c) and washing in the case of the washing machine (appliance 100b). The functional block sequence 120a (FIG. 2B) is used in the rice cooker (appliance 100a), the functional block sequence 120b (FIG. 2C) is used in the washing machine (appliance 100b), and the functional block sequence 120c (FIG. 2D) is used in the microwave oven (appliance 100c). The appliance 100 executes the operation in the order of the functional blocks 110 arranged in the functional block sequence 120. Therefore, it is possible to update the function/operation of the appliance 100 by changing the arrangement of the functional blocks 110 or changing a parameter set in the functional block 110. Details of the functional block sequence 120 will be described later.

In the third layer, a platform server 130 that manages various information in the appliance control system 1000 is arranged. The platform server 130 includes a sequence manager, a device manager, and various databases. The sequence manager manages the functional block sequence 120, the device manager manages the registered information on the appliance 100 that can use the functional block sequence 120, and the various databases manage user information on users who can use the functional block sequence 120.

In the fourth layer, a user application server 132 in which each functional block sequence 120 is presented as a user application is arranged. The functional block sequence 120 presented in the user application server 132 is downloaded to the appliance 100. The downloaded functional block sequence 120 is enabled in the appliance 100. When a further functional block sequence 120 is downloaded to the appliance 100, the further functional block sequence 120 is enabled in the appliance 100.

The third and fourth layers of the appliance control system 1000 may be integrated. In that process, the platform server 130 and the user application server 132 are integrally configured. Alternatively, the third and fourth layers in the appliance control system 1000 may be arranged in the same layer. Alternatively, the third and fourth layers in the appliance control system 1000 may be omitted. In that process, the functional block sequence 120 is downloaded to the appliance 100 from the user apparatus (not shown) owned by the user.

FIGS. 2A to 2E show configurations of the functional block 110 used in the appliance control system 1000. FIG. 2A shows the basic configuration of the functional block 110. The functional block 110 is defined in a functional unit that the appliance 100 can execute and has a “block name” determined by the detail of the function. A plurality of parameters determined by the function can be set in the functional block 110. Each parameter set in the functional block 110 is output to the driver 104. When the driver 104 receives the parameter from the functional block 110, the driver 104 controls the operation of the component 102 according to the parameter.

FIG. 2B shows a functional block 110a of “pre-cook” in the rice cooker (appliance 100a) of FIG. 1A. In the functional block 110a of “pre-cook”, parameters including pot bottom temperature, duration, convection pattern, bottom (outside) IH time, and bottom (inside) IH time can be set. FIG. 2C shows a functional block 110b of “boil” in the rice cooker (appliance 100a) of FIG. 1A, FIG. 2D shows a functional block 110c of “steam” in the rice cooker (appliance 100a) of FIG. 1A, and FIG. 2E shows a functional block 110d of “keep warm”. A plurality of parameters can be set in each of the functional block 110b to the functional block 110d as well. The same applies to the functional block 110 in the washing machine (appliance 100b) and the microwave oven (appliance 100c) of FIG. 1A.

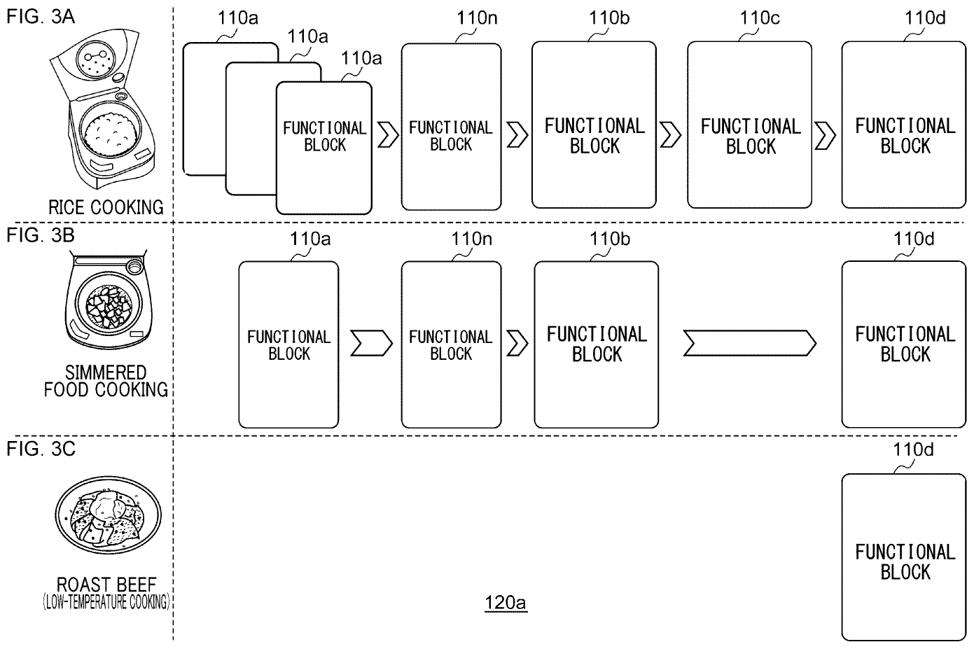

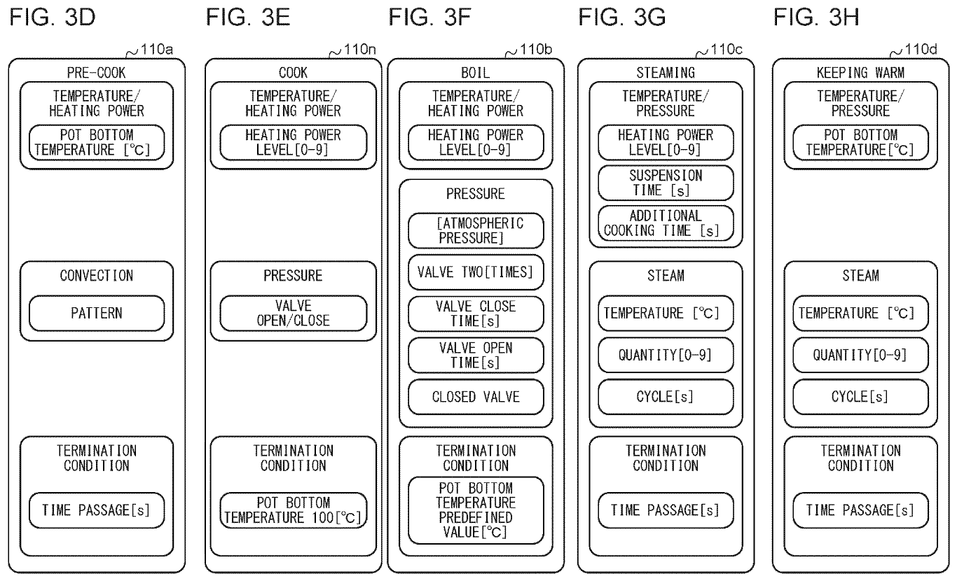

FIGS. 3A to 3H show configurations of the functional block sequence 120 used in the appliance control system 1000 and, particularly, the functional block sequence 120a used in the rice cooker (appliance 100a) of FIG. 1A. FIG. 3A shows a sequence for “rice cooking”, FIG. 3B shows a sequence for “simmered food cooking”, and FIG. 3C shows a sequence for “roast beef (low temperature cooking)”.

In the sequence for “rice cooking” shown in FIG. 3A, three “pre-cook” functional blocks 110a (FIG. 3D), a “cook” functional block 110n (FIG. 3E), the “boil” functional block 110b (FIG. 3F), the “steam” functional block 110c (FIG. 3G), and the “keep warm” functional block 110d (FIG. 3H) are arranged in order. In the three “pre-cook” functional blocks 110a, mutually different parameters are set. By thus arranging the three “pre-cook” functional blocks 110a in which mutually different parameters are set in order, a three-step pre-cooking can be executed.

In the sequence for “simmered food cooking” shown in FIG. 3B, the “pre-cook” functional block 110a, the “cook” functional block 110n, the “boil” functional block 110b, and the “keep warm” functional block 110d are arranged in order. The sequence for “roast beef (low temperature cooking)” shown in FIG. 3C includes the “keep warm” functional block 110d. By thus changing the type, arrangement, and parameters of the functional block 110 used, it is possible to execute processes directed to different purposes of “rice cooking”, “simmered food cooking”, and “roast beef (low-temperature cooking)”. The same applies to the functional block sequence 120 in the washing machine (appliance 100b) and the microwave oven (appliance 100c) of FIG. 1A.

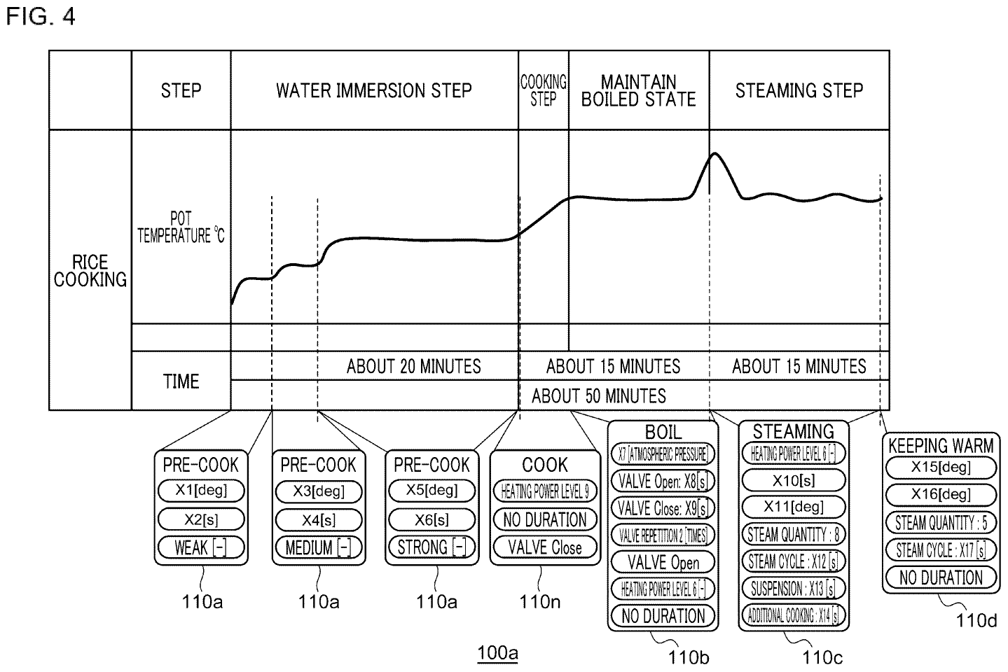

FIG. 4 shows an overview of the operation of the appliance 100 and, particularly, the rice cooker (appliance 100a) of FIG. 1A. This shows the operation of the appliance 100a according to the sequence for “rice cooking” in FIG. 3A. In the water immersion step, the three “pre-cook” functional blocks 110a with mutually different parameters set are executed in order so that the components 102 corresponding to them operate according to the parameters. As a result, the pot temperature increases in a stepwise manner over time. Following this, the “cook” functional block 110n, the “boil” functional block 110b, the “steam” functional block 110c, and the “keep warm” functional block 110d are executed in order so that the components 102 corresponding to them operate according to the parameters. That is, rice is cooked in the appliance 100a by executing a plurality of functional blocks 110 in order.

### (2) Configuration of Appliance Control System

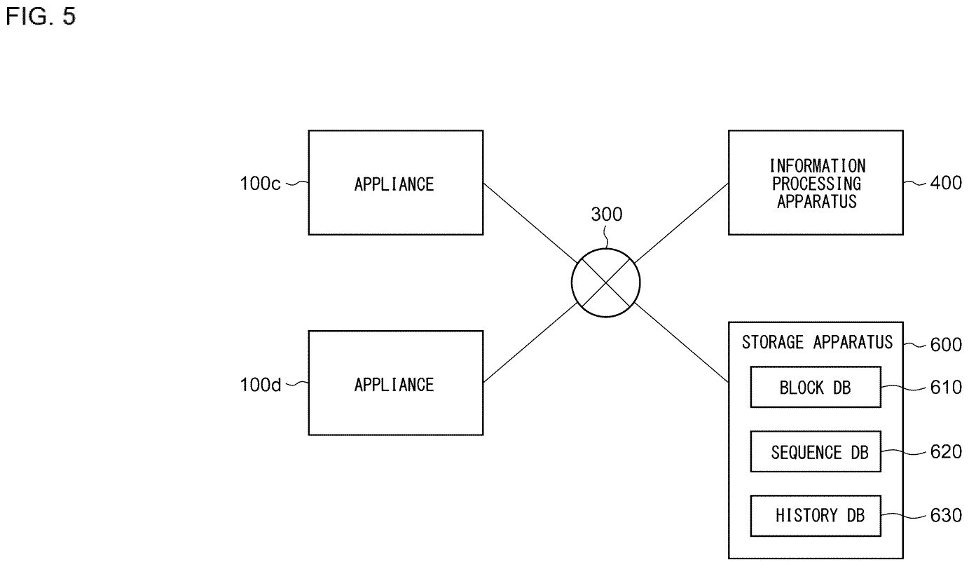

FIG. 5 shows another configuration of the appliance control system 1000. The appliance control system 1000 includes the appliance 100c, the appliance 100d, a network 300, an information processing apparatus 400, and a storage apparatus 600. In addition, the storage apparatus 600 includes a block DB 610, a sequence DB 620, and a history DB 630.

The appliance 100c is, for example, the microwave oven shown in FIG. 1A, and the appliance 100d is, for example, a toaster. The appliances 100 execute the processing of the first layer of FIG. 1A. Each appliance 100 is connected to the network 300. In network 300, either wired communication, wireless communication, or a combination of the wired communication and the wireless communication may be carried out. The information processing apparatus 400 and the storage apparatus 600 are also connected to the network 300.

The storage apparatus 600 is, for example, a hard disk drive (HDD) or a solid state drive (SSD), and can store electronic information. The block DB 610 stores the functional blocks 110 described above. The sequence DB 620 stores the functional block sequence 120 described above. The history DB 630 will be described later.

The information processing apparatus 400 is a server for executing processing of the second layer and the fourth layer of FIG. 1A, and is the user application server 132 of FIG. 1A. The information processing apparatus 400 is, for example, a server including a processor, a memory, and the like, or a computer such as a cloud server. The information processing apparatus 400 acquires the functional block sequence 120 stored in the sequence DB 620 in response to a request for providing the functional block sequence 120 from the appliance 100 via the network 300, and transmits the acquired functional block sequence 120 to the appliance 100.

After executing the processing according to the functional block sequence 120, the appliance 100 transmits information (hereinafter, also referred to as “execution report”) related to the executed functional block sequence 120 to the information processing apparatus 400. The information processing apparatus 400 acquires the execution report from the appliance 100 via the network 300, and reflects the information on the functional block sequence 120 included in the acquired execution report in the history DB 630 indicating an execution history of the functional block sequence 120.

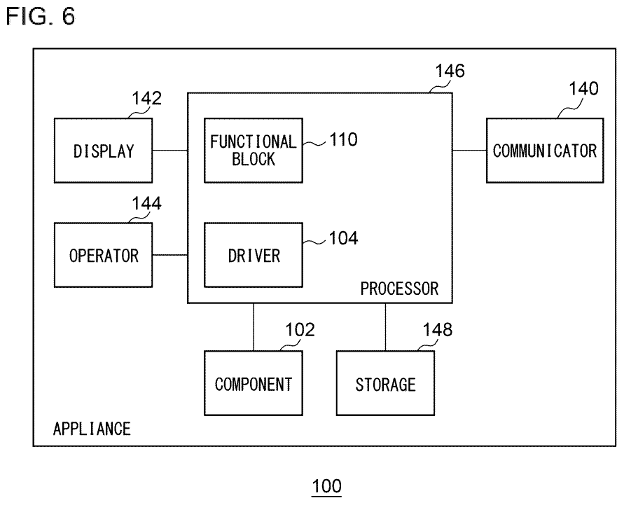

FIG. 6 shows a configuration of the appliance 100. The appliance 100 includes the component 102, a communicator 140, a display 142, an operator 144, a processor 146, and a storage 148. The processor 146 includes the functional block 110 and the driver 104. The appliance 100 is a household electrical/mechanical appliance such as a rice cooker, a washing machine, a microwave oven, or a toaster. A plurality of components 102, a plurality of drivers 104, and a plurality of functional blocks 110 are provided as shown in FIGS. 1B to 1G, but only a respective one is shown here for the sake of clarity of the drawings.

The display 142 displays information from the processor 146. For example, the display 142 can receive information on a list of the functional block sequences 120 executable in the appliance 100 from the processor 146 and display the list. The operator 144 is an interface capable of receiving an input from a user, and is, for example, a button. In addition, the display 142 and the operator 144 may be integrated as a touch panel. The operator 144 outputs the received input to the processor 146. One example of the input is an instruction to select the functional block sequence 120 to be executed.

The processor 146 receives the input from the operator 144, for example, the instruction to select the functional block sequence 120 to be executed. If receiving the instruction, the processor 146 confirm whether or not the functional blocks 110 included in the functional block sequence 120 are stored in the storage 148. In a case where the functional blocks 110 included in the functional block sequence 120 are stored in the storage 148, the processor 146 reads out the functional block 110 from the storage 148. The processor 146 causes the component 102 to operate via the driver 104 in the order of the functional blocks 110 in the functional block sequence 120.

Meanwhile, in a case where the functional blocks 110 included in the functional block sequence 120 is not stored in the storage 148, the processor 146 is connected to the network 300 via the communicator 140 and executes communication with the information processing apparatus 400 via the network 300. The processor 146 transmits the request for providing the functional block sequence 120 from the communicator 140 to the information processing apparatus 400. If receiving the functional block sequence 120 from the information processing apparatus 400 via the communicator 140, the processor 146 stores the functional block sequence 120 in the storage 148. Subsequently, the processor 146 reads out the functional block 110 from the storage 148 and then executes similar operations as before. After completing the operations of the component 102 according to the functional block sequence 120, the processor 146 transmits the execution report from the communicator 140 to the information processing apparatus 400.

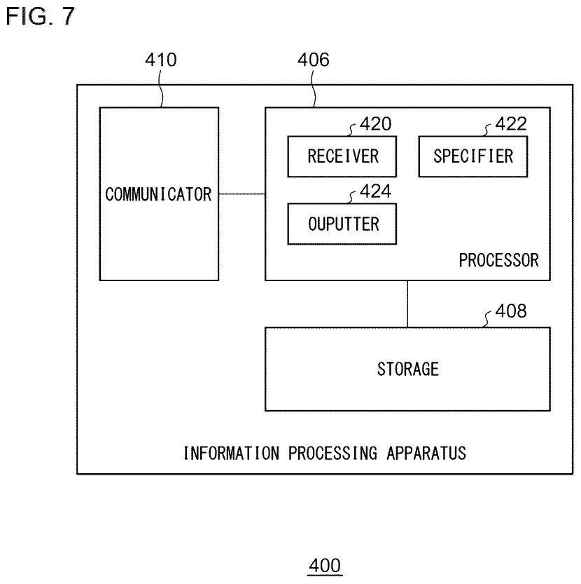

FIG. 7 shows a configuration of the information processing apparatus 400. The information processing apparatus 400 includes a processor 406, a storage 408, and a communicator 410. The processor 406 includes a receiver 420, a specifier 422, and an outputter 424. The processor 406 executes a process in the information processing apparatus 400. The storage 408 stores information used in the processor 406. The communicator 410 is connected to the network 300 and communicates with the appliance 100 or the storage apparatus 600 via the network 300.

For example, the communicator 410 receives the request for providing the functional block sequence 120 from the appliance 100. The processor 406 accesses the storage apparatus 600 via the communicator 140 and acquires the functional block sequence 120 stored in the sequence DB 620 from the storage apparatus 600. The communicator 140 transmits the acquired functional block sequence 120 to the appliance 100. Further, the communicator 410 receives the execution report from the appliance 100. The processor 406 reflects the functional block sequence 120 included in the execution report in the history DB 630.

### (3) Reflection of Change in Functional Block

If the appliance 100 compatible with the Internet of Things (IoT) becomes widespread, the appliance 100 is expected to become highly functional. As the appliance 100 becomes highly functional, the number of types of selectable functions during the operations increases. This makes it difficult for the user to select a function suitable for the user. In order to enhance user convenience, it is effective to reflect past setting changes in the appliance 100 for future use. However, the reflection of such changes is generally limited to the same appliance 100.

However, different types of appliance 100 may also have similar functions. For example, the microwave oven and the toaster both have the common function of heating. In such case, if a change in a setting according to a preference of the user for one appliance 100 is also reflected in a setting of another appliance 100, the user convenience is enhanced. In other words, if a preference that can be shared in living activities is reflected across the appliances 100, the user convenience is enhanced.

In the present embodiment, in a case where the user changes a setting of the microwave oven (appliance 100c) according to the preference of the user, the change is also reflected in a setting of the toaster (appliance 100d). The change in the setting of the appliance 100 is implemented by changing the parameters of the functional block 110 to be executed by the appliance 100. Here, (3-1) processes in microwave oven (appliance 100c) and information processing apparatus 400, and (3-2) processes in toaster (appliance 100d) and information processing apparatus 400 will be described in order.

### (3-1) Processes in Microwave Oven (Appliance 100c) and Information Processing Apparatus 400

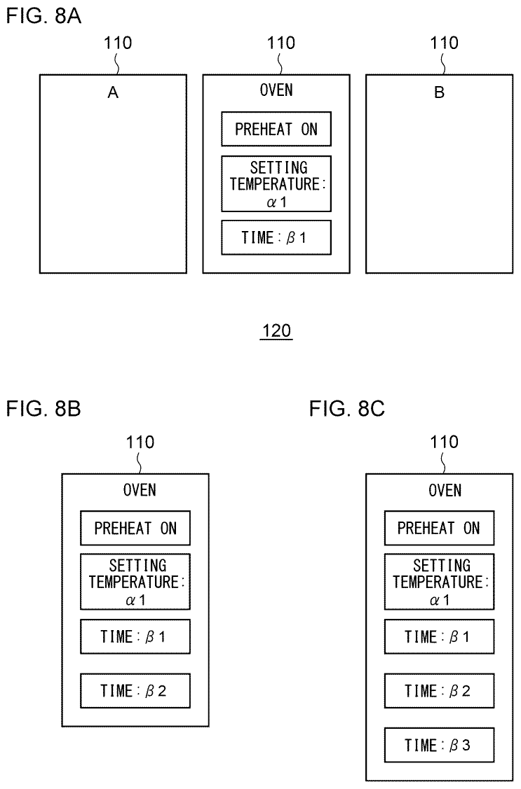

FIGS. 8A to 8C show the functional block sequences 120 executed in the microwave oven (appliance 100c). In particular, FIG. 8A is the functional block sequence 120 in the microwave oven (appliance 100c), which is a default functional block sequence 120 for any recipe. In the functional block sequence 120, the functional block 110 of “A”, the functional block 110 of “oven”, and the functional block 110 of “B” are arranged in order. The functional block 110 of “A” and the functional block 110 of “B” are optional functional blocks 110. The number of the functional blocks 110 of “A” and the number of the functional blocks 110 of “B” each are not limited to “1”. The functional block 110 of “oven” is the functional block 110 highlighted in the present embodiment. In the functional block 110 of “oven”, three parameters of “preheat on/off”, “set temperature”, and “time” can be set. In a default state, “preheat on”, “set temperature: α1”, and “time: β1” are set. The user causes the microwave oven (appliance 100c) to execute the functional block sequence 120 of FIG. 8A.

The user who has confirmed a dish produced by executing the functional block sequence 120 determines that scorching of the dish is not sufficient. The user manipulates the operator 144 of the appliance 100 to cause the microwave oven (appliance 100c) to execute the functional block 110 of “oven” again at the “set temperature: α1” and the “time: β2”. The functional block 110 of “oven” through the process is shown as in FIG. 8B, and the “time: β2” is added to the “time: β1” as default. The user causes the microwave oven (appliance 100c) to execute the functional block 110 of “oven” set to the “time: β2”.

The user who has confirmed the dish produced by executing the functional block 110 of “oven” determines to grill a little more. The user manipulates the operator 144 of the appliance 100 to cause the microwave oven (appliance 100c) to execute the functional block 110 of “oven” again at the “set temperature: α1” and “time: β3”. The functional block 110 of “oven” through the process is shown as in FIG. 8C, and the “time: β3” is added to the “time: β1” and the “time: β2” shown in FIG. 8B. The user causes the microwave oven (appliance 100c) to execute the functional block 110 of “oven” set to the “time: β3”. The user who has confirmed the dish produced by executing the functional block 110 of “oven” determines that scorching of the dish is sufficient.

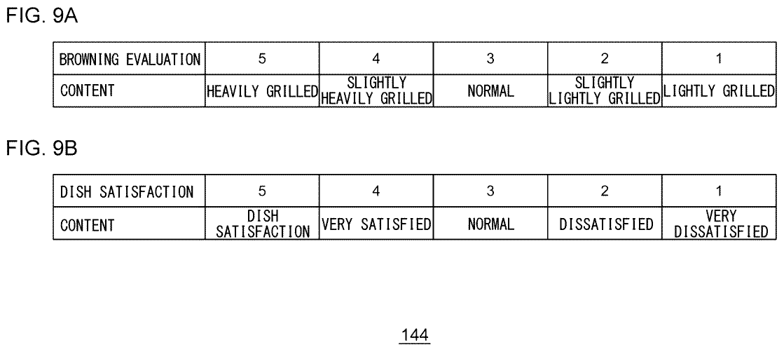

After the cooking is finished, the user manipulates the operator 144 of the microwave oven (appliance 100c) to input a subjective evaluation on the cooking or the functional block 110 of “oven”. FIGS. 9A and 9B show the subjective evaluation input by the operator 144. The subjective evaluation includes “browning evaluation” in FIG. 9A and “dish satisfaction” in FIG. 9B. The “browning evaluation” is an index for evaluating degrees of browning, and as shown in FIG. 9A, the evaluation is shown in five stages of “5” to “1”. The five stage of the browning evaluation of “5” to “1” indicate “heavily grilled”, “slightly heavily grilled”, “normal”, “slightly lightly grilled”, and “lightly grilled”, respectively. In the present embodiment, since the functional block 110 of a grill function such as the “oven” is highlighted, the subjective evaluation includes the “browning evaluation”. However, in a case where the functional block 110 of a function other than the grill is highlighted, the evaluation other than the “browning evaluation” is included in the subjective evaluation.

The “dish satisfaction” is an index for evaluating degrees of satisfaction of a dish, and as shown in FIG. 9B, the satisfaction is shown in five stages of “5” to “1”. The five stages of the dish satisfaction of “5” to “1” indicate “very satisfied”, “satisfied”, “normal”, “dissatisfied”, and “very dissatisfied”, respectively. The browning evaluation or the dish satisfaction may not be five stages.

The processor 146 of the microwave oven (appliance 100c) receives, from the operator 144, any one of “5” to “1” of the subjective evaluation, that is, the browning evaluation, and any one of “5” to “1” of the dish satisfaction. In addition, the processor 146 receives the “time: β2” and the “time: β3” for the functional block 110 of “oven”. The “time: β2” and the “time: β3” are additional times, and the additional times can be said to be modification values for the functional block 110 of “oven”. The processor 146 generates data to be reported to the information processing apparatus 400 based on the received information.

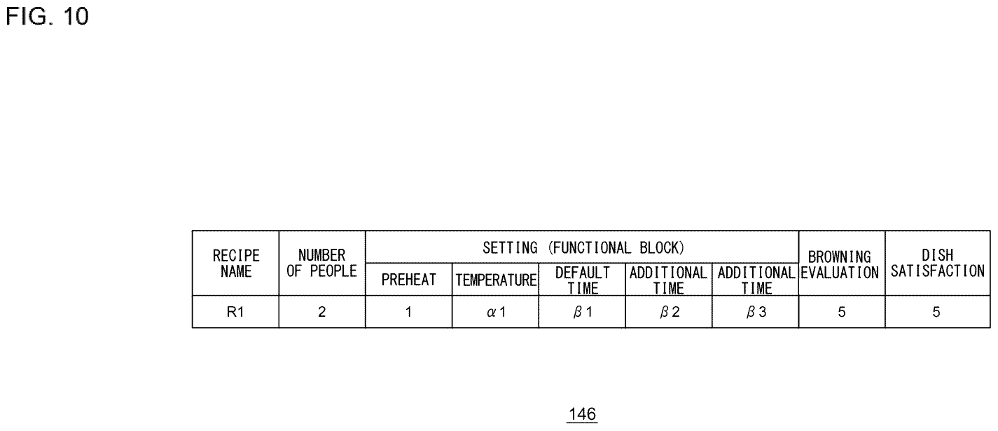

FIG. 10 shows data generated in the processor 146. The data includes a dish name, the number of people, settings (functional block 110), the browning evaluation, and the dish satisfaction. The dish name is information for identifying the functional block sequence 120, and the number of people is information indicating an amount of a dish to be produced by the functional block sequence 120. The information on the dish name and the number of people is received when the functional block sequence 120 is selected in the microwave oven (appliance 100c). In the preheat, temperature, and default time in the setting (functional block 110), default setting values for the functional block 110 of “oven” are input. The “time: β2” and the “time: β3” are input for two additional times, and “5” is input for the browning evaluation and the dish satisfaction. The communicator 140 of the microwave oven (appliance 100c) includes the data generated by the processor 146 in the execution report, and then transmits the execution report to the information processing apparatus 400 via the network 300.

The communicator 410 of the information processing apparatus 400 receives the execution report from the microwave oven (appliance 100c). The processor 406 extracts the information of the subjective evaluation, that is, the browning evaluation and the dish satisfaction from the execution report. The processor 406 acquires a determination flag for the functional block 110 of “oven” based on the browning evaluation and the dish satisfaction. The determination flag is information indicating the preference of the user.

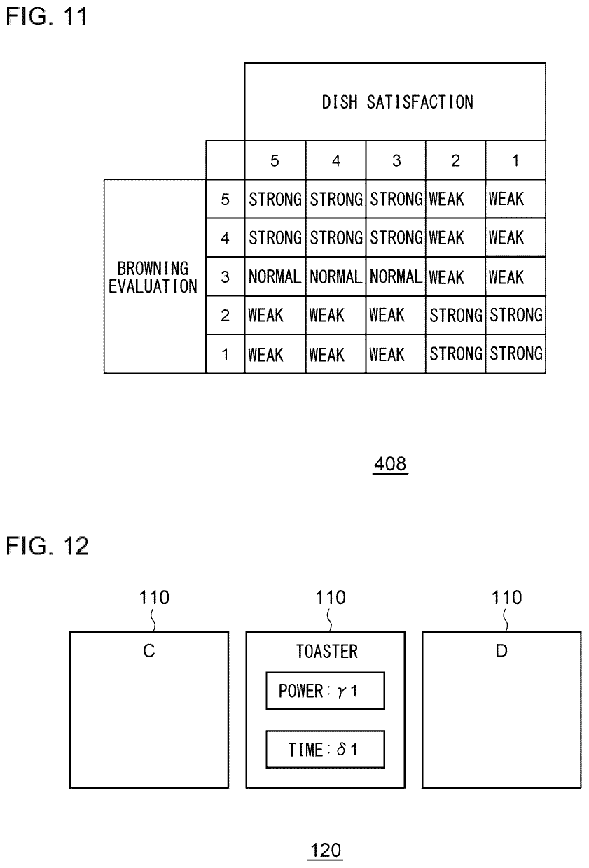

FIG. 11 shows a data structure of a table stored in the storage 408. A vertical axis indicates the browning evaluation, and a horizontal axis indicates the dish satisfaction. “Strong” indicates a determination flag “strong preference”, “normal” indicates a determination flag “normal preference”, and “weak” indicates a determination flag “weak preference”. The processor 406 acquires the determination flags by referring to a corresponding table based on the received browning evaluation and the dish satisfaction. For example, if the browning evaluation is “5” and the dish satisfaction is “5”, the determination flag “strong preference” is acquired. If the browning evaluation is “3” and the dish satisfaction is “5”, the determination flag “normal” is acquired. If the browning evaluation is “1” and the dish satisfaction is “5”, the determination flag “weak preference” is acquired. The processor 406 stores the execution report and the determination flags in the history DB 630 by transmitting the execution report and the determination flags from the communicator 410 to the storage apparatus 600. This corresponds to storing the determination flags and the modification values in the history DB 630 in association with the functional block 110 of “oven”.

### (3-2) Processes in Toaster (Appliance 100d) and Information Processing Apparatus 400

The user manipulates the operator 144 of the toaster (appliance 100d) to select a dish scheduled to be cooked, that is, the functional block sequence 120 scheduled to be executed in the toaster (appliance 100d). The communicator 140 transmits the information on the selected functional block sequence 120 to the information processing apparatus 400 via the network 300.

The communicator 410 of the information processing apparatus 400 receives the information on the functional block sequence 120 from the toaster (appliance 100d). The receiver 420 receives, from the communicator 410, the information on the functional block sequence 120 scheduled to be executed by the toaster (appliance 100d). In a case where the functional block sequence 120 scheduled to be executed by the toaster (appliance 100d) is referred to as a “first functional block sequence 120”, the functional block sequence 120 that has already been executed by the microwave oven (appliance 100c) is referred to as a “second functional block sequence 120”.

FIG. 12 shows the functional block sequence 120 (first functional block sequence 120) scheduled to be executed in the toaster (appliance 100d) and the default functional block sequence 120 for any recipe. In the functional block sequence 120, the functional block 110 of “C”, the functional block 110 of “toaster”, and the functional block 110 of “D” are arranged in order. The functional block 110 of “C” and the functional block 110 of “D” are optional functional blocks 110. The number of the functional blocks 110 of “C” and the number of the functional blocks 110 of “D” each are not limited to “1”. The functional block 110 of “toaster” is the functional block 110 highlighted in the present embodiment. In the functional block 110 of “toaster”, two parameters of “power” and “time” can be set. In a default state, “power: γ1” and “time: δ1” are set. In a case where the “power” is referred to as a first parameter, the “time” is referred to as a second parameter.

The specifier 422 acquires information on the second functional block sequence 120 having already been executed, by referring to the history DB 630 stored in the storage apparatus 600 via the network 300. The specifier 422 searches for a second functional block 110 similar to each of the functional blocks 110 (hereinafter, also referred to as “first functional blocks 110”) included in the first functional block sequence 120 among the plurality of functional blocks 110 (hereinafter, also referred to as “second functional blocks 110”) included in the second functional block sequence 120. Here, the toaster (appliance 100d) scheduled to execute the first functional block sequence 120 and the microwave oven (appliance 100c) that has already executed the second functional block sequence 120 are of different types.

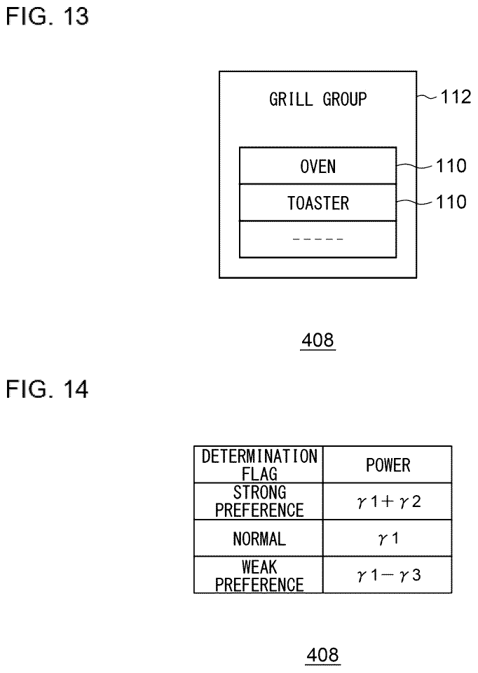

FIG. 13 shows a data structure of the table stored in the storage 408. The functional blocks 110 having similar functions are put together in advance as a group 112. Here, the functional block 110 of “oven” and the functional block 110 of “toaster” corresponding to the “grill” function are put together in the group 112 of “grill”. With reference to the table in FIG. 13, in a case where the functional block 110 in the first functional block sequence 120 and the functional block 110 in the second functional block sequence 120 are included in the same group 112, the specifier 422 determines that these functional blocks 110 are similar. For example, it is determined that the functional block 110 of “oven” and the functional block 110 of “toaster” included in the group 112 of “grill” are similar. The specifier 422 specifies the functional block 110 of the second functional block sequence 120 determined to be similar, for example, the functional block 110 of “oven”.

The processor 406 acquires the determination flag and the modification value “additional time” for the functional block 110 specified in the specifier 422. This corresponds to, for example, acquiring the determination flag and the modification value “additional time” for the functional block 110 of “oven” described above. As described above, the functional block 110 in the first functional block sequence 120 to be processed, for example, the functional block 110 of “toaster” includes two parameters of the “power” and the “time” as shown in FIG. 12.

FIG. 14 shows a data structure of another table stored in the storage 408. The determination flag for the functional block 110 of “oven” is associated with the “power” of the functional block 110 of “toaster”. For example, the determination flag “normal” is associated with the power “γ1”. The power “γ1” is a default power in FIG. 12. In addition, the determination flag “strong preference” is associated with power “γ1+γ2”, and the determination flag “weak preference” is associated with power “γ1−γ3”. Therefore, the power in a case of the determination flag “strong preference” is made larger than the power in a case of the determination flag “normal”, and the power in a case of the determination flag “weak preference” is made smaller than the power in a case of the determination flag “normal”. The processor 406 acquires the power based on the determination flag by referring to the table in FIG. 14. This corresponds to modifying the power based on the determination flag.

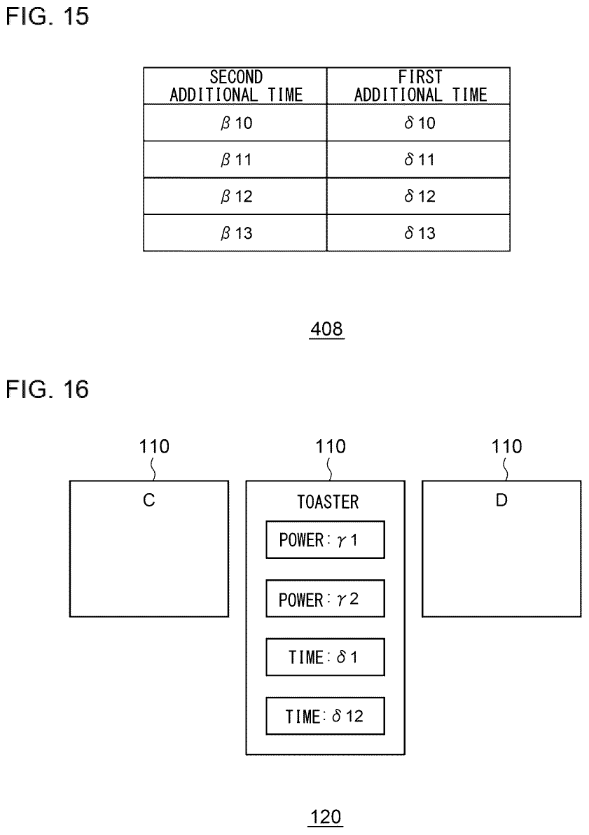

FIG. 15 shows a data structure of still another table stored in the storage 408. The additional time (hereinafter, referred to as a “second additional time”) of the functional block 110 of “oven” is associated with the additional time (hereinafter, referred to as a “first additional time”) of the functional block 110 of “toaster”. The second additional time indicates, for example, a total value of the “time: β2” and the “time: β3” described above. The processor 406 acquires the first additional time based on the second additional time by referring to the table in FIG. 15. Hitherto, the first additional time and the second additional time are set to positive values for the user with the determination flag “strong preference”. However, the first additional time and the second additional time may be set to negative values for the user with the determination flag “weak preference”. This corresponds to modifying the time of the functional block 110 of “toaster” based on the second additional time.

FIG. 16 shows a functional block sequence 120 including the functional blocks 110 modified in the processor 406. Here, it is assumed that the determination flag for the functional block 110 of “oven” is “strong preference” and the second additional time is “β12”. By the processing described above, in the power of the functional block 110 of “toaster”, “power: γ2” is added to the default “power: γ1”. In addition, in the time of the functional block 110 of “toaster”, the first additional time “δ12” is added to the default “time: δ1”. The functional block 110 of “C” and the functional block 110 of “D” remain as default.

The outputter 424 outputs the functional block sequence 120 generated in the processor 406, for example, the first functional block sequence 120 including the modified functional block 110 of “toaster” to the communicator 410. The communicator 410 transmits the functional block sequence 120 to the toaster (appliance 100d) via the network 300. The toaster (appliance 100d) executes the functional block sequence 120 received from the information processing apparatus 400.

In the above description, the specifier 422 determines similarity between the functional block 110 in the first functional block sequence 120 and the functional block 110 in the second functional block sequence 120 by using the specification of the group 112 as shown in FIG. 13. The specifier 422 may determine the similarity between the functional block 110 in the first functional block sequence 120 and the functional block 110 in the second functional block sequence 120 by using artificial intelligence (AI). In addition, the processor 406 acquires the power corresponding to the determination flag and the first additional time corresponding to the second additional time by using the tables as shown in FIGS. 14 and 15. The processor 406 may acquire the power corresponding to the determination flag and the first additional time corresponding to the second additional time by using the AI.

The features are implemented in hardware such as a Central Processing Unit (CPU), a memory, or other Large Scale Integrations (LSIs) of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

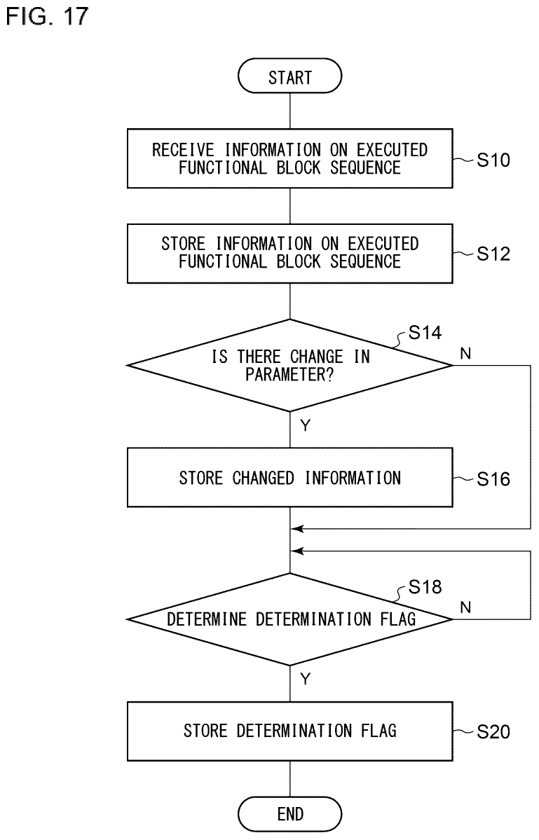

An operation of the appliance control system 1000 having the above configuration will be described. FIG. 17 is a flowchart showing a storage procedure by the information processing apparatus 400. The communicator 410 receives information on the executed functional block sequence 120 (S10). The processor 406 stores the information on the executed functional block sequence 120 in the history DB 630 (S12). If a parameter change is included (Y in S14), the processor 406 stores the changed information in the history DB 630 (S16). If the parameter change is not included (N in S14), step 16 is skipped. If the processor 406 has not determined the determination flag (N in S18), the processor 406 stands by. If processor 406 has determined the determination flag (Y in S18), the processor 406 stores the determination flag in the history DB 630 (S20).

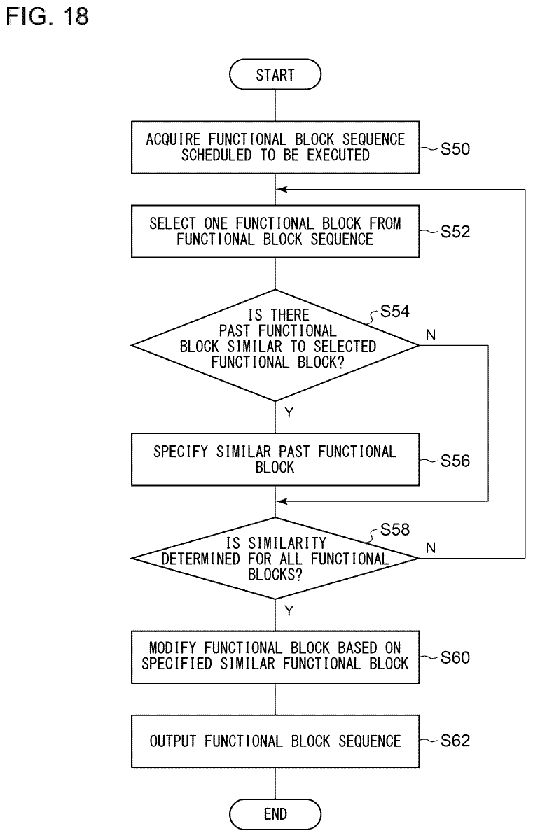

FIG. 18 is a flowchart showing a modification procedure by the information processing apparatus 400. The receiver 420 acquires the functional block sequence 120 scheduled to be executed (S50). The specifier 422 selects one functional block 110 from the functional block sequence 120 (S52). In a case where there is a past functional block 110 similar to the selected functional block 110 (Y in S54), the specifier 422 specifies the similar past functional block 110 (S56). In a case where there is no past functional block 110 similar to the selected functional block 110 (N in S54), step 56 is skipped. If the similarity is not determined for all the functional blocks 110 (N in S58), the process returns to step 52. If the similarity is determined for all the functional blocks 110 (Y in S58), the processor 406 modifies the functional blocks 110 based on the specified similar functional block 110 (S60). The outputter 424 outputs the functional block sequence 120 (S62).

According to the present embodiment, since the functional block 110 similar to the functional block 110 included in the first functional block sequence 120 scheduled to be executed by the appliance is specified from the already executed second functional block sequence 120, it is possible to associate another functional block 110 included in a different functional block sequence 120. In addition, since the functional block 110 included in the first functional block sequence 120 is modified based on the determination flag and the modification value for the functional block 110 included in the second functional block sequence 120, it is possible to reflect the changes in the parameters between different appliances 100. In addition, since the changes in the parameters are reflected between different appliances 100, the user convenience can be enhanced. In addition, since the determination flags indicating the preferences are used, the same index can be used among different appliances 100.

In addition, in a case where the second block sequence is executed, the browning evaluation and the dish satisfaction of the user are received, and the determination flags are determined based on the browning evaluation and the dish satisfaction, so that the preferences of the user can be reflected in the determination flags. In addition, since the modification value of the functional block 110 included in the first functional block sequence 120 is determined based on the modification value of the functional block 110 included in the second functional block sequence 120, the preferences of the user can be reflected in the modification values.

### Second Embodiment

Next, the second embodiment will be described. The second embodiment relates to the appliance control system 1000 that reflects the changes in the parameters among different types of appliances 100, as in the first embodiment. In the first embodiment, the determination flags reflecting the preferences of the user are introduced, and a relationship of the modification values between the functional blocks 110 of the appliances 100 of different types is defined, whereby the changes in the parameters between the appliances 100 of different types can be reflected. Such first embodiment is based on the premise that the same user is involved. Meanwhile, the second embodiment aims to reflect the changes in the parameters between different users as in the first embodiment. The appliance control system 1000 according to the second embodiment is of a type similar to that in FIGS. 1A to 1G and FIG. 5, the appliance 100 is of a type similar to that in FIG. 6, and the information processing apparatus 400 is of a type similar to that in FIG. 7. Here, differences from the first embodiment will be mainly described.

The communicator 410 of the information processing apparatus 400 receives the information on the functional block sequence 120 scheduled to be executed from the appliance 100. The appliance 100 corresponds to, for example, the toaster (appliance 100d) of the first embodiment. The receiver 420 receives, from the communicator 410, the information on the functional block sequence 120 scheduled to be executed by the appliance 100. In addition, the receiver 420 receives the determination flag indicating the preference of the user who is scheduled to cause the appliance 100 to execute the functional block sequence 120. The determination flag is determined, in the information processing apparatus 400, the browning evaluation and the like included in the execution report when the user has caused another appliance 100 to execute based on the dish satisfaction.

The determination flag is stored, for example, in the storage 408.

The specifier 422 acquires information on the functional block sequence 120 having already been executed, by referring to the history DB 630 stored in the storage apparatus 600 via the network 300. Similarly to the above, the specifier 422 specifies the functional block 110 similar to the functional block 110 included in the functional block sequence 120 scheduled to be executed from the history DB 630.

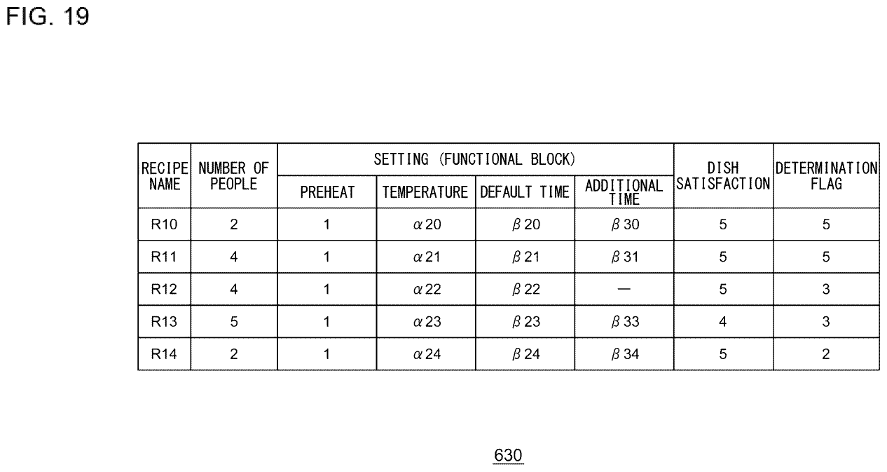

FIG. 19 shows a data structure of the history DB 630. The data structure is generated based on the data included in the execution report received from the appliance 100 used by each of a plurality of users. In addition, for clarity of description, FIG. 19 shows only the functional block 110 specified in the specifier 422. Similarly to the data in FIG. 10, the history DB 630 includes the dish name, the number of people, the settings (functional block 110), and the dish satisfaction. The history DB 630 also includes the determination flag determined in the information processing apparatus 400. Since content of each item is the same as those described above, the description thereof will be omitted here. In this way, the history DB 630 stores, for each of the plurality of functional blocks 110, the determination flag indicating a preference of another user, a subjective evaluation of the other user, and the modification value for the parameters of the functional block 110. In a case where the determination flag received by receiver 420 is referred to as a “first determination flag”, each of the determination flags included in history DB 630 is referred to as a “second determination flag”.

The processor 406 selects the functional block 110 having the second determination flag of which the content is the same as that of the first determination flag from the history DB 630. In addition, the processor 406 further selects, from the selected functional blocks 110, the functional block 110 having a relatively high subjective evaluation, for example, the functional block 110 with the dish satisfaction of “5”. In addition, the processor 406 derives a modification value based on an additional time for the further selected functional block 110. For example, in a case where there is a plurality of the further selected functional blocks 110, the processor 406 derives one additional time (second additional time) by executing a statistical process such as averaging on the additional times for the further selected functional blocks 110. In addition, the processor 406 acquires the first additional time from the second additional time by referring to the table in FIG. 15.

The processor 406 acquires the power from the first determination flag by referring to the table in FIG. 14. The processor 406 modifies the functional block 110 included in the functional block sequence 120 scheduled to be executed based on the acquired power and the first additional time as in the first embodiment. The processor 406 may modify the functional block 110 included in the functional block sequence 120 scheduled to be executed by using the AI for the history DB 630. The outputter 424 outputs the functional block sequence 120 generated in the processor 406 to the communicator 410. The communicator 410 transmits the functional block sequence 120 to the appliance 100 via the network 300.

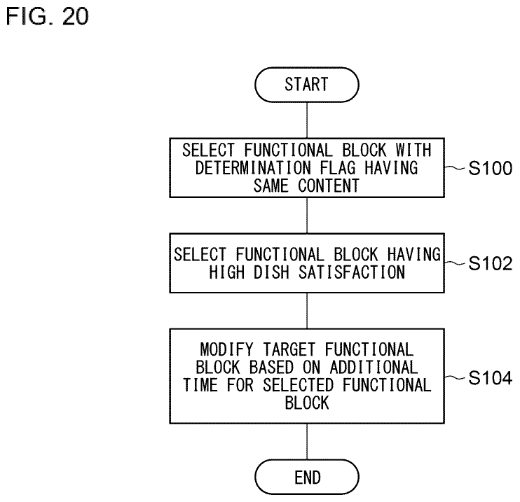

An operation of the appliance control system 1000 having the above configuration will be described. FIG. 20 is a flowchart showing a modification procedure by the information processing apparatus 400. The processor 406 selects the functional block 110 with the determination flag having the same content (S100). The processor 406 selects a functional block 110 having high dish satisfaction (S102). The processor 406 modifies the target functional block 110 based on the additional time for the selected functional block 110 (S104).

According to the present embodiment, since the modification value of the functional block 110 included in the first functional block sequence 120 is determined using the determination flag, the dish satisfaction, and the modification value of the other user stored in the history DB 630, it is possible to reflect the changes in the parameters between different appliances 100. In addition, since the modification value of the functional block 110 included in the first functional block sequence 120 is determined using the determination flag, the dish satisfaction, and the modification value of the other user stored in the history DB 630, the user convenience can be enhanced.

An overview of one aspect of the present disclosure is as follows. An information processing method according to one aspect of the present disclosure includes: a step of receiving information on a first block sequence that is a block sequence in which blocks defined in a functional unit executable by an appliance are arranged in an order of operation and that is a block sequence scheduled to be executed by the appliance; a step of specifying a second block similar to a first block included in the first block sequence from a second block sequence that is the block sequence having already been executed by an appliance of a type different from a type of the appliance scheduled to execute; a step of modifying the first block based on a determination flag indicating a preference of a user for the second block and a modification value for a parameter of the second block; and a step of outputting the first block sequence including the modified first block.

The method may further include, in a case where the second block sequence is executed, a step of receiving a subjective evaluation of the user on the second block and the modification value for the parameter of the second block; a step of acquiring a determination flag for the second block based on the subjective evaluation of the user on the second block; and a step of storing the determination flag and the modification value in a database in association with the second block. The modification step may use the determination flag and the modification value stored in the database.

The first block may include a first parameter and a second parameter. In the modification step, the first parameter may be modified based on the determination flag, and the second parameter may be modified based on the modification value.

Another aspect of the present disclosure is also an information processing method. The method includes: a step of receiving information on a block sequence that is a block sequence in which blocks defined in a functional unit executable by an appliance are arranged in an order of operation and that is scheduled to be executed by the appliance; a step of receiving a first determination flag indicating a preference of a user scheduled to cause the appliance to execute the block sequence; a step of modifying a first block using a database that stores a plurality of pieces of information on a second block that is similar to the first block included in the block sequence and that has already been executed by another user; and a step of outputting the block sequence including the modified first block. The database stores, for each of the plurality of second blocks, a second determination flag indicating a preference of the other user, a subjective evaluation of the other user, and a modification value for a parameter of each of the second blocks. In the step of modification, (1) the second blocks having the second determination flag with the same content as the first determination flag are selected from the database, (2) the second blocks having a relatively high subjective evaluation are further selected from the selected second blocks, and (3) the first block is modified based on the modification value for the further selected second blocks and the first determination flag.

Still another aspect of the present disclosure is an information processing apparatus. The apparatus includes: a receiver structured to receive information on a first block sequence that is a block sequence in which blocks defined in a functional unit executable by an appliance are arranged in an order of operation and that is a block sequence scheduled to be executed by the appliance; a specifier structured to specify a second block similar to a first block included in the first block sequence from a second block sequence that is the block sequence having already been executed by an appliance of a type different from a type of the appliance scheduled to execute; a processor structured to modify the first block based on a determination flag indicating a preference of a user for the second block and a modification value for a parameter of the second block; and an outputter structured to output the first block sequence including the modified first block.

Still another aspect of the present disclosure is also an information processing apparatus. The apparatus includes: a first receiver structured to receive information on a block sequence that is a block sequence in which blocks defined in a functional unit executable by an appliance are arranged in an order of operation and that is scheduled to be executed by the appliance; a second receiver structured to receive a first determination flag indicating a preference of a user scheduled to cause the appliance to execute the block sequence; a processor structured to modify the first block using a database storing information on a plurality of second blocks that are similar to the first block included in the block sequence and that have already been executed by another user; and an outputter structured to output the block sequence including the modified first block. The database stores, for each of the plurality of second blocks, a second determination flag indicating a preference of the other user, a subjective evaluation of the other user, and a modification value for a parameter of each of the second blocks. The processor (1) selects the second blocks having the second determination flag with the same content as the first determination flag from the database, (2) further selects the second blocks having a relatively high subjective evaluation from the selected second blocks, and (3) modifies the first block based on the modification value for the further selected second blocks and the first determination flag.

The present disclosure has been described above based on the embodiments. It is to be understood by a person skilled in the art that the embodiments are examples, various modifications can be made to combinations of the respective components or the respective processing processes, and such modifications are also within the scope of the present disclosure.

In the first and second embodiments, the functional block 110 of “oven” and the functional block 110 of “toaster” common to the function of “grill” are subjects that have been described. However, the present disclosure is not limited thereto, and for example, the functional block 110 common to functions other than the “grill” may also be used. According to the present modification, application scopes of the first and second embodiments can be expanded.

What is claimed is:

1. An information processing method comprising:
receiving information on a first block sequence that is a block sequence in which blocks defined in a functional unit executable by an appliance are arranged in an order of operation and that is a block sequence scheduled to be executed by the appliance;
specifying a second block similar to a first block included in the first block sequence from a second block sequence that is the block sequence having already been executed by an appliance of a type different from a type of the appliance scheduled to execute;
modifying the first block based on a determination flag indicating a preference of a user for the second block and a modification value for a parameter of the second block; and
outputting the first block sequence including the modified first block.

2. The information processing method according to claim 1, further comprising:
receiving, in a case where the second block sequence is executed, a subjective evaluation of the user on the second block and the modification value for the parameter of the second block;
acquiring the determination flag for the second block based on the subjective evaluation of the user on the second block; and
storing the determination flag and the modification value in a database in association with the second block, wherein
in the modifying, the determination flag and the modification value stored in the database are used.

3. The information processing method according to claim 1, wherein
the first block includes a first parameter and a second parameter, and
in the modifying, the first parameter is modified based on the determination flag, and the second parameter is modified based on the modification value.

4. An information processing method comprising:
receiving information on a block sequence that is a block sequence in which blocks defined in a functional unit executable by an appliance are arranged in an order of operation and that is scheduled to be executed by the appliance;
receiving a first determination flag indicating a preference of a user scheduled to cause the appliance to execute the block sequence;
modifying the first block using a database storing information on a plurality of second blocks that are similar to the first block included in the block sequence and that have already been executed by another user; and
outputting the block sequence including the modified first block, wherein
the database stores, for each of the plurality of second blocks, a second determination flag indicating a preference of the other user, a subjective evaluation of the other user, and a modification value for a parameter of each of the second blocks, and
in the modifying, (1) the second blocks having the second determination flag with the same content as the first determination flag are selected from the database, (2) the second blocks having a relatively high subjective evaluation are further selected from the selected second blocks, and (3) the first block is modified based on the modification value for the further selected second blocks and the first determination flag.

5. An information processing apparatus comprising:
a receiver structured to receive information on a first block sequence that is a block sequence in which blocks defined in a functional unit executable by an appliance are arranged in an order of operation and that is a block sequence scheduled to be executed by the appliance;
a specifier structured to specify a second block similar to a first block included in the first block sequence from a second block sequence that is the block sequence having already been executed by an appliance of a type different from a type of the appliance scheduled to execute;
a processor structured to modify the first block based on a determination flag indicating a preference of a user for the second block and a modification value for a parameter of the second block; and
an outputter structured to output the first block sequence including the modified first block.

6. An information processing apparatus comprising:
a first receiver structured to receive information on a block sequence that is a block sequence in which blocks defined in a functional unit executable by an appliance are arranged in an order of operation and that is scheduled to be executed by the appliance;
a second receiver structured to receive a first determination flag indicating a preference of a user scheduled to cause the appliance to execute the block sequence;
a processor structured to modify the first block using a database storing information on a plurality of second blocks that are similar to the first block included in the block sequence and that have already been executed by another user; and
an outputter structured to output the block sequence including the modified first block, wherein
the database stores, for each of the plurality of second blocks, a second determination flag indicating a preference of the other user, a subjective evaluation of the other user, and a modification value for a parameter of each of the second blocks, and
the processor (1) selects the second blocks having the second determination flag with the same content as the first determination flag from the database, (2) further selects the second blocks having a relatively high subjective evaluation from the selected second blocks, and (3) modifies the first block based on the modification value for the further selected second blocks and the first determination flag.

7. A program causing a computer to:
receive information on a first block sequence that is a block sequence in which blocks defined in a functional unit executable by an appliance are arranged in an order of operation and that is a block sequence scheduled to be executed by the appliance;
specify a second block similar to a first block included in the first block sequence from a second block sequence that is the block sequence having already been executed by an appliance of a type different from a type of the appliance scheduled to execute;
modify the first block based on a determination flag indicating a preference of a user for the second block and a modification value for a parameter of the second block; and
output the first block sequence including the modified first block.

8. A program causing a computer to:
receive information on a block sequence that is a block sequence in which blocks defined in a functional unit executable by an appliance are arranged in an order of operation and that is scheduled to be executed by the appliance;
receive a first determination flag indicating a preference of a user scheduled to cause the appliance to execute the block sequence;
modify the first block using a database storing information on a plurality of second blocks that are similar to the first block included in the block sequence and that have already been executed by another user; and
output the block sequence including the modified first block, wherein
the database stores, for each of the plurality of second blocks, a second determination flag indicating a preference of the other user, a subjective evaluation of the other user, and a modification value for a parameter of each of the second blocks, and
in the modification, (1) the second blocks having the second determination flag with the same content as the first determination flag are selected from the database, (2) the second blocks having a relatively high subjective evaluation are further selected from the selected second blocks, and (3) the first block is modified based on the modification value for the further selected second blocks and the first determination flag.
